(19) United States
(12) Patent Application Publication
(10) Pub. No.: US 2013/0156570 A1
(43) Pub. Date: Jun. 20, 2013

(54) WIND COLLECTION APPARATUS

(71) Applicants: Chang-Hsien TAI, Pingtung (TW); Shi-Wei LO, Pingtung (TW); Fang-Pin CHEN, Pingtung (TW)

(72) Inventors: Chang-Hsien TAI, Pingtung (TW); Shi-Wei LO, Pingtung (TW); Fang-Pin CHEN, Pingtung (TW)

(21) Appl. No.: 13/584,396

(22) Filed: Aug. 13, 2012

(30) Foreign Application Priority Data
Dec. 19, 2011 (TW) 100147188

(51) Int. Cl. F03D 1/04

(52) U.S. Cl. 415/208.1

(57) ABSTRACT

A wind collection apparatus includes an outer tube and an inner tube assembly. The outer tube has a front end and a rear end. The inner tube assembly is installed in the outer tube and has an inner channel and an outer channel. An air-guiding channel is formed between an outer circumferential wall of the inner tube assembly and an inner circumferential wall of the outer tube. The inner channel has two openings. One of the openings is located at the front end and the other one of the openings is located at the rear end. The outer channel is in communication with the inner channel and the air-guiding channel at two ends of the outer channel.

### BACKGROUND OF THE INVENTION

1. Field of the Invention

The present invention generally relates to a wind collection apparatus and, more particularly, to a wind collection apparatus that is designed in a special structure capable of guiding the airflow.

2. Description of the Related Art

Conventional wind collection apparatuses are installed in wind power generators for wind collections. The collected wind drives the impellers of the wind power generators to rotate so as to produce shaft work. The shaft work is then converted into electricity. Since electricity is converted from wind power, the amount of electricity that can be generated by the wind collection apparatuses depends on the ability of the wind collection apparatuses to collect the wind.

Referring to FIG. 1, a conventional wind collection apparatus is shown. The wind collection apparatus may be of a tube 9 having an air inlet 91. The tube 9 may form an air channel 92 therein. The air inlet 91 collects and guides the wind into the air channel 92.

However, since air-guiding effects are not created in the air channel 92, airflows will not be speeded up in the air channel 92 of the tube 9 when traveling in the air channel 92. Thus, the tube 9 is not able to draw a larger amount of air into the air channel 92, limiting the ability of the wind collection apparatus to collect air. Consequently, the electricity generation efficiency of the wind collection apparatus is low.

### SUMMARY OF THE INVENTION

It is therefore the objective of this invention to provide a wind collection apparatus that can create improved air-guiding effects therein for drawing a larger amount of air into said apparatus.

In the preferred embodiment, a wind collection apparatus includes an outer tube and an inner tube assembly. The outer tube has a front end and a rear end. The inner tube assembly is installed in the outer tube and has an inner channel and an outer channel. An air-guiding channel is formed between an outer circumferential wall of the inner tube assembly and an inner circumferential wall of the outer tube. The inner channel has two openings. One of the openings is located at the front end and the other one of the openings is located at the rear end. The outer channel is in communication with the inner channel and the air-guiding channel at two ends of the outer channel.

In a preferred form shown, the inner tube assembly comprises a first tube and a second tube. The first tube and the second tube jointly form the inner channel, the outer channel is formed between the first tube and the second tube.

In the preferred form shown, the space of the outer channel is gradually narrowed from the front end to the rear end of the outer tube.

In the preferred form shown, the inner channel of the inner tube assembly has a narrow section.

In the preferred form shown, the inner channel of the inner tube assembly has a narrow section located on the first tube.

In the preferred form shown, the air-guiding channel has a space that is gradually narrowed towards the rear end of the outer tube.

In the preferred form shown, the outer tube has a varying diameter at the front end that is larger than a diameter of the outer tube at the rear end.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a conventional wind collection apparatus.

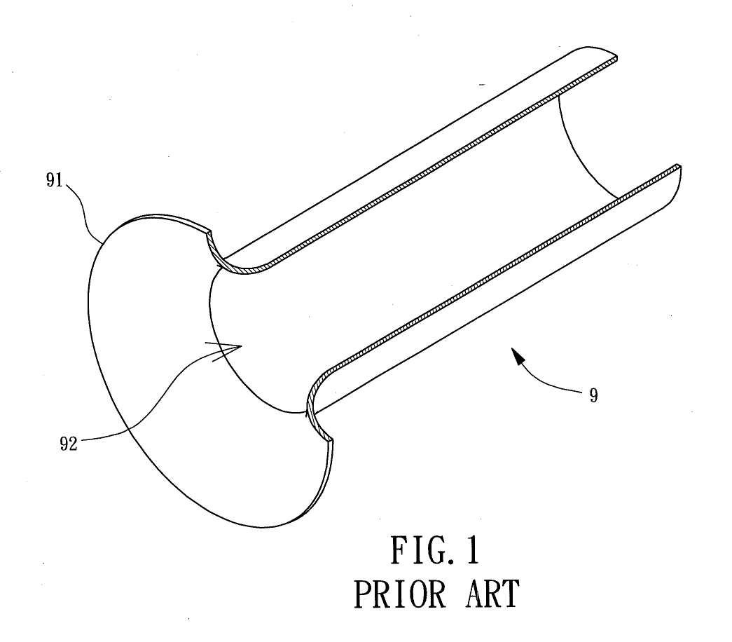

FIG. 2 is a cross-sectional view of a wind collection apparatus according to a preferred embodiment of the invention.

FIG. 3 shows airflows passing through the wind collection apparatus of the invention.

In the various figures of the drawings, the same numerals designate the same or similar parts. Furthermore, when the terms “first”, “second”, “third”, “fourth”, “inner”, “outer” “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

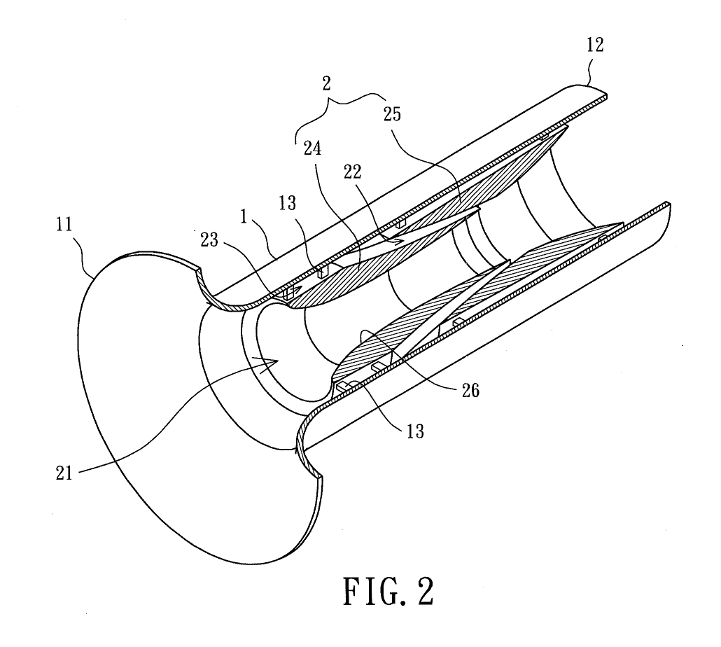

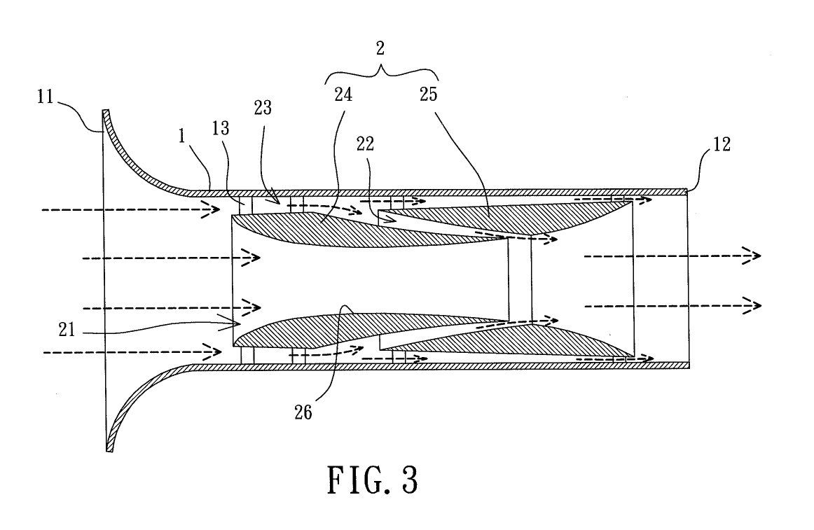

Referring to FIGS. 2 and 3, a wind collection apparatus is disclosed according to a preferred embodiment of the invention. The wind collection apparatus includes an outer tube 1 and an inner tube assembly 2 installed in the outer tube 1.

The outer tube 1 is a hollow tube having a front end 11 and a rear end 12. The front end 11 may be of a horn-like shape having an opening. The outer tube 1 has a varying diameter at the front end 11 that is larger than the diameter of the outer tube 1 at the rear end 12. The structure allows the front end 11 to collect and guide a larger amount of air into the outer tube 1.

The inner tube assembly 2 has an inner channel 21 and an outer channel 22. An air-guiding channel 23 is formed between the outer circumferential wall of the inner tube assembly 2 and the inner circumferential wall of the outer tube 1. The inner channel 21 has two openings, one of which is located at the front end 11 and the other one is located at the rear end 12 of the outer tube 1. Air can travel from the front end 11 to the rear end 12 of the outer tube 1 through the inner channel 21.

The outer channel 22 is in communication with the inner channel 21 and the air-guiding channel 23 at two ends thereof Air in the air-guiding channel 23 can flow from the outer channel 22 to the inner channel 21, creating an air-pulling effect in the inner channel 21. The air-pulling effect will help in drawing a larger amount of air into the inner channel 21 via the front end 11. In this embodiment, the space of the outer channel 22 is gradually narrowed from the front end 11 to the rear end 12 of the outer tube 1. Air will flow from the outer channel 22 to the inner channel 21 at a faster speed due to the gradually-narrowed space of the outer channel 22, creating an improved air-guiding effect in the inner channel 21.

The air-guiding channel 23 can be formed in any manner. In this embodiment, a plurality of ribs 13 is connected between the outer circumferential wall of the inner tube assembly 2 and the inner circumferential wall of the outer tube 1. Under arrangement of the ribs 13, the space between the inner tube assembly 2 and the outer tube 1 forms the air-guiding channel 23. Air can flow from the front end 11 of the outer tube 1 into the air-guiding channel 23. A portion of the air that flows into the air-guiding channel 23 will be guided to the rear end 12 along the space between the inner tube assembly 2 and the outer tube 1, creating an air-pulling effect at the rear end 12. The air-pulling effect at the rear end 12 will help in drawing the air out of the inner channel 21, efficiently discharging the air. Meanwhile, the other portion of the air that flows into the air-guiding channel 23 will flow into the inner channel 21 via the outer channel 22, creating an air-pulling effect in the inner channel 21. In the air-guiding channel 23, the distance between the outer tube 1 and the inner tube assembly 2 is gradually reduced towards the rear end 12 of the outer tube 1. In this arrangement, the air-guiding channel 23 has a gradually-narrowed space towards the rear end 12 of the outer tube 1. Thus, when air flows from the front end 11 into the air-guiding channel 23, the flow of the air will be speeded up due to the gradually-narrowed space of the air-guiding channel 23. As the air flows out of the air-guiding channel 23 at a faster speed, the speeded air will push a larger amount of air out of the inner channel 21, thereby creating an improved air-pulling effect.

The inner tube assembly 2 may have a variety of implementations. In the embodiment, the inner tube assembly 2 has a first tube 24 and a second tube 25. The inner channel 21 is formed in the first tube 24 and the second tube 25. The outer channel 22 is formed between the first tube 24 and the second tube 25. Since the outer channel 22 between the first tube 24 and the second tube 25 is circular and has a larger space than the space between the second tube 25 and the outer tube 1, the air that flows into the air-guiding channel 23 will be evenly guided to the inner channel 21, improving the air-pulling effect in the inner channel 21.

The inner channel 21 of the inner tube assembly 2 has a narrow section 26. The inner channel 21 has a varying diameter and forms the narrow section 26 with minimal diameter before the rear end 12. The diameter of the inner channel 21 is gradually increased from the narrow section 26 towards the rear end 12. When air flows into the inner channel 21, the air will be speeded up due to the gradually-narrow space. Air will reach a maximum speed at the narrow section 26 and flow smoothly after the narrow section 26 due to the gradually-widened space of the inner channel 21. In this embodiment, the narrow section 26 is formed on the first tube 24, but is not limited thereto.

In summary, when air flows into the front end 11, the air will flow into the inner channel 21 and the air-guiding channel 23 at the same time. The air that flows into the inner channel 21 will reach the maximum speed at the narrow section 26 of the first tube 24. The air that flows into the air-guiding channel 23 will be separated into two portions. One portion of the air will flow to the rear end 12 along the space between the outer tube 1 and the second tube 25. The other portion of the air will flow into the outer channel 22 and the inner channel 21 in order, creating the air-pulling effect in the inner channel 21. The air-pulling effect will help in drawing a larger amount of air into the inner channel 21 via the front end 11. Under the air-pulling effects in the outer channel 22 and the air-guiding channel 23, a larger amount of air will be drawn into the inner channel 21 via the front end 11. Thus, the air in the inner channel 21 will be speeded up, increasing the air capacity of the wind collection apparatus.

The wind collection apparatus in the preferred embodiment is able to create an air-pulling effect in the inner channel, increasing the amount of air collected.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A wind collection apparatus comprising:
an outer tube having a front end and a rear end; and
an inner tube assembly installed in the outer tube and having an inner channel and an outer channel, wherein an air-guiding channel is formed between an outer circumferential wall of the inner tube assembly and an inner circumferential wall of the outer tube, wherein the inner channel has two openings, wherein one of the openings is located at the front end, wherein the other one of the openings is located at the rear end, and wherein the outer channel is in communication with the inner channel and the air-guiding channel at two ends of the outer channel.

2. The wind collection apparatus as claimed in claim 1, wherein the inner tube assembly comprises a first tube and a second tube, wherein the first tube and the second tube jointly form the inner channel, and wherein the outer channel is formed between the first tube and the second tube.

3. The wind collection apparatus as claimed in claim 1, wherein the space of the outer channel is gradually narrowed from the front end to the rear end of the outer tube.

4. The wind collection apparatus as claimed in claim 1, wherein the inner channel of the inner tube assembly has a narrow section.

5. The wind collection apparatus as claimed in claim 2, wherein the inner channel of the inner tube assembly has a narrow section located on the first tube.

6. The wind collection apparatus as claimed in claim 1, wherein the air-guiding channel has a space that is gradually narrowed towards the rear end of the outer tube.

7. The wind collection apparatus as claimed in claim 1, wherein the outer tube has a varying diameter at the front end that is larger than a diameter of the outer tube at the rear end.
